(19) United States
(12) Patent Application Publication
(10) Pub. No.: US 2009/0095627 A1
(43) Pub. Date: Apr. 16, 2009

(54) SENSOR FOR MEASURING THE CONCENTRATION OF A GAS COMPONENT IN A GAS MIXTURE

(75) Inventors: Lothar Diehl, Gerlingen (DE); Thomas Hermann Seiler, Stuttgart (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/090,792

(22) PCT Filed: Sep. 29, 2006
(86) PCT No.: PCT/EP2006/066888

§ 371 Date: Oct. 8, 2008

(30) Foreign Application Priority Data
Oct. 26, 2005 (DE) 10 2005 051 194.5

(51) Int. Cl. G01N 27/26

(52) U.S. Cl. 204/425

(57) ABSTRACT

Disclosed is a sensor for measuring the concentration of a gas component in a gas mixture. Said sensor comprises a solid electrolyte and electrodes which are separated from each other by means of the solid electrolyte and of which an outer electrode is exposed to the gas mixture while an inner electrode is disposed in a hollow space that is separated from the gas mixture with the aid of a diffusion barrier. The inventive sensor is characterized in that an additional outer electrode is exposed to the exhaust gas, said additional outer electrode being impinged upon by a current whose sign is the opposite of the current by which the outer electrode is impinged upon.

### STATE OF THE ART

The invention is based on a sensor for measuring the concentration of a gas component in a gas mixture according to the generic term of claim 1.

Such a sensor is known for example from DE 101 51 328 A1. The sensor has two cells, whereby one serves as a Nernst cell, which determines the oxygen content in a measuring gas area. The second cell is a pump cell, which changes the oxygen content in the measuring gas area. Thereby the oxygen amount that is pumped in or out is so adjusted that there is constantly a λ=1-gas in the measuring gas area or measuring volume. The absolute value and sign of the pump current can determine the exhaust gas composition in a wide scope between rich (λ<1) and lean (λ>1).

During an alteration of the exhaust gas composition from rich to lean or reversed a gas exchange takes place at the exhaust-sided pump electrode, which leads to a launching of an interfering signal in the Nernst cell. Hereby the probe signal, for example the signal of the pump current over the time at about λ=1, shows an overshoot or a counter-oscillator that can be identified as λ=1 waviness. This λ=1 waviness operates interferingly especially during the application for the single cylinder detection and the single cylinder regulation. Furthermore it is obstructive for a quick probe dynamic.

FIG. 2 schematically describes the signal course during the occurrence of such a λ=1 waviness, marked with the reference sign 10.

The invention is therefore based on the purpose to improve the sensor of the type described above so that this obstructive λ=1 waviness is reduced.

### ADVANTAGES OF THE INVENTION

According to this invention the purpose is reached by a sensor with the characteristics of claim 1.

Advantageous improvements and configurations of the sensor are the subject-matter of the subsidiary claims that are based and dependent on claim 1.

The basic idea of the invention is to add oxygen from the exhaust gas to the measuring volume behind the diffusion barrier by a further pump electrode that is exposed to the exhaust gas. The oxygen that has been added this way is then additionally pumped out during the operation of the sensor, so that a too lean defined output signal originates. This way a clear relation between the pump current value and the exhaust gas composition from a rich to a lean area is possible, without having the pump current to pass a shift in direction. Preferably an additional outer electrode is arranged at the side of the solid electrolyte that is averted from the outer electrode. Due to this arrangement an oxygen feed into the measuring volume is optimally reached.

Thereby it can be provided that the additional outer electrode is impinged with current over at least one separate feed line. It can also be provided that the additional outer electrode is electrically conductive and connected to a ground connection of a radiator of the sensor. In this case a current source in a control unit is connected to an inner electrode, so that no other additional feed line is required.

The outer electrode that is exposed to the gas mixture, that is the already known exhaust-sided pump electrode, is covered by a protective coating, which is an already known method. Hereby it can be avoided that due to the continuing pumping out of oxygen a gas exchange takes place at this electrode. Especially the λ=1 waviness is substantially reduced. The protective coating that covers the outer electrode can be completed very thickly since the increased pump voltage demand during a rich operation does not constitute the limit anymore. The pumping in of oxygen during a rich operation is partially undertaken by the additional outer pump electrode.

The further, additional outer pump electrode can be covered by a protective coating that does merely serve the protection of the electrode, but does not influence the pump performance of the electrode.

The solid electrolyte is gas-opaque itself.

### DRAWING

Further advantages and characteristics of the invention are the subject-matter of the following description and of the graphics of examples of embodiments of a sensor according to the invention.

The drawing shows:

FIG. 1 schematically the construction of a sensor according to the state of the art for measuring the concentration of a gas component in a gas mixture;

FIG. 2 schematically the λ=1 waviness of the pump current over the time according to the state of the art;

FIG. 3 schematically the construction of a first example of embodiment of a sensor according to this invention;

FIG. 4 schematically the construction of a second example of embodiment of a sensor according to this invention;

FIG. 5 the pump current over λ of a sensor as shown in FIG. 1 according to the state of the art and

FIG. 6 the pump current over λ of a sensor according to this invention.

### DESCRIPTION OF THE EXAMPLES OF EMBODIMENT

A sensor as shown in FIG. 1 according to the state of the art and labeled as a wide band lambda probe embraces a gas-opaque solid electrolyte body 120, which can be built e.g. in layers. A gas leak 122 is provided in the solid electrolyte body 120, through which exhaust gas gets over a diffusion barrier 150 into a measuring volume 130. A pump electrode 170 is arranged in the measuring volume 130. An outer electrode 160 is arranged on the outside of the solid electrolyte body 120, which is covered by a protective coating 230. The outer electrode 160 and the inner pump electrode 170 build a pump cell 180, which allows to pump oxygen out of the measuring volume 130. Therefore a pump voltage Uₚ is arranged at the outer electrode so that a pump current Iₚ flows.

A further reference electrode 190 is arranged in the solid electrolyte. The reference electrode 190 and the inner pump electrode 170 built a Nernst cell 195.

The pump cell 180 changes the oxygen content in the measuring volume 130. The Nernst cell 195 determines the oxygen content in the measuring volume 130. The oxygen amount that is pumped in and out is so regulated that there is always a λ=1-gas in the measuring volume 130. The exhaust gas composition can be exactly determined in a wide range between rich and lean by the absolute value and the sign of the pump current. Due to this reason such a sensor is also called wide band lambda probe.

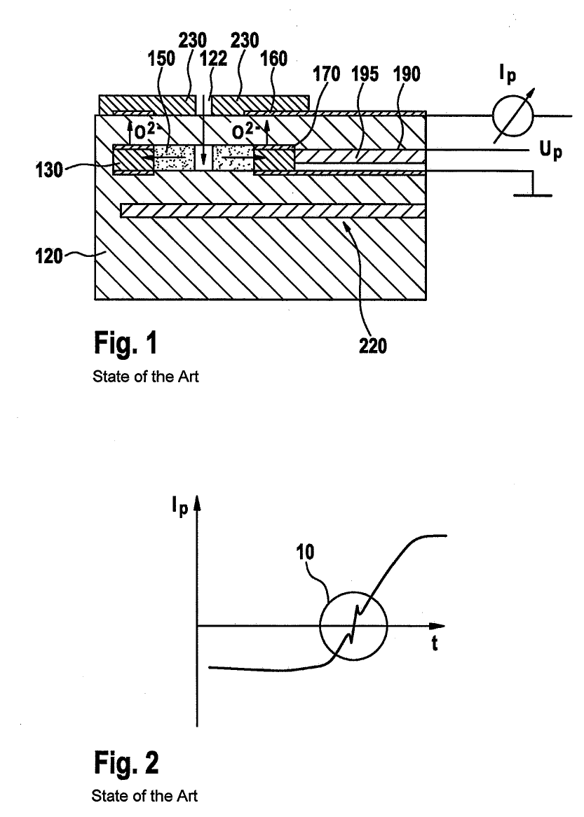

However, during an alteration of the exhaust gas composition, that is the crossover from a rich to a lean mixture, an overshoot or counter oscillator, as shown in FIG. 2, occurs among other things at approximately λ=1, which is labeled as the λ=1 waviness. This λ=1 waviness is especially obstructive during the application for the single cylinder detection and -regulation. Furthermore it hinders a quick probe dynamic.

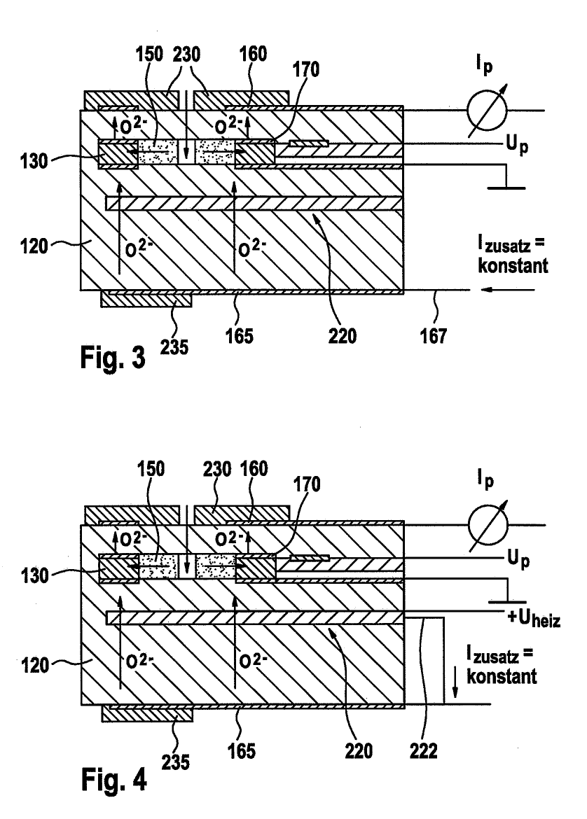

To avoid such a λ=1 waviness and to allow a high probe dynamic the invention provides that a further, additional outer electrode 165 is arranged at the solid electrolyte body 120 (FIG. 3, FIG. 4). This additional outer electrode 165 is preferably arranged at the side of the solid electrolyte body 120 that is averted from the outer electrode 160. It can be impinged with a constant additional current I_{zusatz} by an additional line 167 as shown in FIG. 3. For protective purposes this additional outer electrode 165 can be covered with a protective coating 235.

In a further example of embodiment, as shown in FIG. 4, the additional outer electrode 165 is electrically conductive and connected to the radiator mass 222, so that an additional line for impinging with additional current I_{zusatz} is not applicable. Furthermore the line of the radiator mass is used for the impinging of the additional electrode 165 with additional current I_{zusatz}.

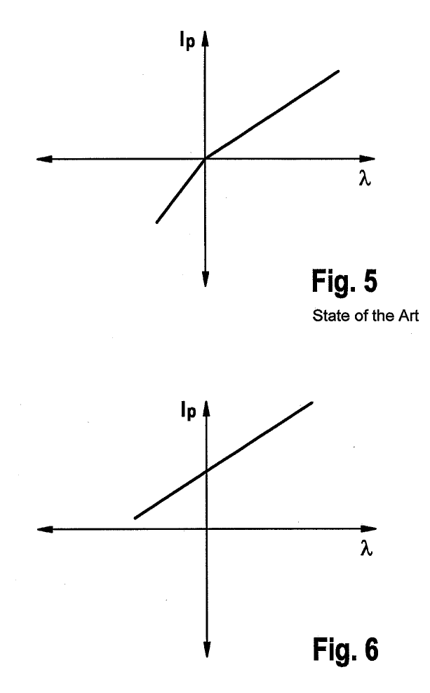

The functionality of the additional outer electrode 165 is subsequently specified in FIG. 5 and FIG. 6.

With a sensor as it was shown in FIG. 1 the pump current Iₚ over λ behaves as shown in FIG. 5. It proceeds from the third quadrant into the first, whereby a bend occurs during the crossover from the third to the first quadrant. This makes an exact relation between the pump current value and the exhaust gas composition from a rich to a lean area difficult.

The invention provides that the inner pump electrode 170 and the additional outer electrode 165 are so impinged with an additional pump current I_{zusatz} having a sign that is adverse to the pump current Iₚ, that oxygen is delivered to the measuring volume 130. This oxygen is now additionally pumped out, so that a too lean defined output signal originates. Is the additional pump current I_{zusatz} big enough, a positive pump current Ip can also occur during a rich exhaust gas. This way an exact relation between pump current value and exhaust gas composition from a rich to a lean area is possible, without having the pump current Iₚ to pass a shift of direction (see FIG. 6). Hereby a faster dynamic of the probe is enabled. The thick protective coating 235 that is arranged by the additional outer electrode 165 avoids that this electrode experiences a gas exchange due to the continuing pumping out of oxygen. Thereby the λ=1 waviness is reduced. According to the actual understanding this gas exchange does not reach all points of the outer electrode 160 at the same time. If there is rich gas at one side of the sensor and lean gas at the other, an electric current flows in the outer electrode and an ionic current in the solid electrolyte body 120 that can consist of e.g. zirconium oxide. The ionic current is linked with a potential drop, which falsifies the potential measurement of the Nernst cell.

1-6. (canceled)

7. A sensor that measures the concentration of a gas component in a gas mixture, the sensor comprising:
a solid electrolyte body that is ion-conductive;
a plurality of electrodes, which are separated from each other by the solid electrolyte body, including a first outer electrode that is exposed to the gas mixture, the first outer electrode impinged with a first current having a first sign, and an inner electrode arranged in a cavity, the inner electrode separated from the gas mixture, a second outer electrode that is exposed to an exhaust gas mixture, wherein the second outer electrode is impinged with a second current having a sign that is opposite to the first sign.

8. A sensor according to claim 1, further comprising arranging the second outer electrode on a first side of the solid electrolyte body, which is opposite of the first outer electrode.

9. A sensor according to claim 1, further comprising impinging the second outer electrode with current over a separate feed line.

10. A sensor according to claim 1, wherein the second outer electrode is electrically conductive and connected to a ground connection of a radiator.

11. A sensor according to claim 1, wherein the second outer electrode is covered by a protective coating.

12. A sensor according to claim 1, wherein the solid electrolyte body is gas-opaque.
